(19) United States
(12) Patent Application Publication
(10) Pub. No.: US 2016/0248990 A1
(43) Pub. Date: Aug. 25, 2016

(54) IMAGE SENSOR AND IMAGE PROCESSING SYSTEM INCLUDING SAME

(71) Applicant: SAMSUNG ELECTRONICS CO., LTD., SUWON-SI (KR)

(72) Inventors: BYUNG JO KIM, SEOUL (KR); SEOG HEON HAM, Suwon-si (KR); SE JUN KIM, Seoul (KR); JI HUN SHIN, Seongnam-si (KR)

(21) Appl. No.: 15/017,714

(22) Filed: Feb. 8, 2016

(30) Foreign Application Priority Data
Feb. 23, 2015 (KR) 10-2015-0025371

(51) Int. Cl. H04N 5/265; H04N 5/369; H04N 5/262; H04N 5/235; H04N 5/378; H04N 5/374

(52) U.S. Cl. CPC H04N 5/265; H04N 5/378; H04N 5/374; H04N 5/2621; H04N 5/2353; H04N 5/3698

(57) ABSTRACT

An image sensor includes a pixel array including preview pixels and capture pixels, a first readout circuit configured to communicate a preview image data generated by the preview pixels to a digital signal processor via a first interface, a second readout circuit configured to communicate a captured image data generated by the capture pixels to the digital signal processor via a second interface different from the first interface, and a controller configured to control the first readout circuit and the second readout circuit to communicate the preview image data and the captured image data in parallel to the digital signal processor.

### CROSS-REFERENCE TO RELATED APPLICATION

This application claims priority under 35 U.S.C. §119(a) from Korean Patent Application No. 10-2015-0025371 filed on Feb. 23, 2015, the disclosure of which is hereby incorporated by reference in its entirety.

### BACKGROUND

Embodiments of the inventive concept relate to image sensors, and more particularly, to image sensors capable of reducing power consumption. Embodiments of the inventive concept further relate to image sensors and image processing systems capable of providing, in parallel, a live view (or preview) image with a still-shot image without liquid crystal display (LCD) blackout, as a user acquires a still shot image.

Digital camera users often want to take a still shot while viewing an object on an LCD screen without LCD blackout. Digital cameras including conventional image sensors are not able to simultaneously provide a live-view (or preview) image along with a still-shot image when such digital cameras are switched from a live-view mode to a still-shot mode. Such inter-module conversion generally results in the occurrence of LCD blackout. To variously use a digital camera under the foregoing conditions—without LCD blackout—an image sensor is required that is capable of continuously providing a still-shot image (or a full-size image). However, this capability markedly increases power consumption by the digital camera, as compared with operation in the typical live-view mode. As will be appreciated by those skilled in the art, power consumption is a particularly important performance feature in mobile operating environments.

### SUMMARY

According to some embodiments of the inventive concept, there is provided an image sensor including a pixel array including preview pixels and capture pixels, a first readout circuit configured to communicate a preview image data generated by the preview pixels to a digital signal processor via a first interface, a second readout circuit configured to communicate a captured image data generated by the capture pixels to the digital signal processor via a second interface different from the first interface, and a controller configured to control the first readout circuit and the second readout circuit to communicate the preview image data and the captured image data in parallel to the digital signal processor. A frame rate for the preview image may be higher than or equal to a frame rate for the captured image.

The controller may set the frame rate for the preview image data to be higher than or equal to the frame rate for the captured image data. The controller may control the second readout circuit to communicate the captured image data to the digital signal processor via the second readout circuit in response to a capture command received while the preview image data is being communicated to the digital signal processor via the first readout circuit.

The image sensor may maintain the first readout circuit active so that the preview image is communicated to the digital signal processor through the first readout circuit when the captured image data is communicated to the digital signal processor via the second readout circuit. The controller may control an exposure time for the preview pixels and capture pixels. The preview image data may be generated with an exposure for a first duration and the captured image data may be generated with an exposure for a second duration different from the first duration.

According to other embodiments of the inventive concept, there is provided an image processing system including an image sensor configured to output a preview image data and a captured image data in parallel, and a digital signal processor configured to receive the preview image data and the captured image data in parallel and to merge the preview image data and the captured image data.

The image sensor may include a pixel array including a plurality of preview pixels and a plurality of capture pixels, a first readout circuit configured to communicate the preview image generated by the plurality of preview pixels to the digital signal processor through a first interface, a second readout circuit configured to communicate the captured image generated by the plurality of capture pixels to the digital signal processor through a second interface different from the first interface, and a controller configured to control the first readout circuit and the second readout circuit to communicate the preview image and the captured image in parallel to the digital signal processor. A frame rate for the preview image may be higher than or equal to a frame rate for the captured image.

The controller may set the frame rate for the preview image to be higher than or equal to the frame rate for the captured image data. The controller may control the second readout circuit to communicate the captured image to the digital signal processor in response to a capture command received while the preview image data is being communicated to the digital signal processor via the first readout circuit.

The image sensor may maintain the first readout circuit active so that the preview image is communicated to the digital signal processor through the first readout circuit when the captured image data is communicated to the digital signal processor via the second readout circuit. The controller may control an exposure time for the preview pixels and the capture pixels. The preview image data may be generated with an exposure for a first duration and the captured image data may be generated with an exposure for a second duration different from the first duration.

According to other embodiments of the inventive concept, there is provided an electronic device, comprising; a Digital Signal Processor (DSP) that generates merged image data, a display that displays an image in response to the merged image data received from the DSP, and an image sensor including a pixel array comprising preview pixels that generate preview image data and capture pixels that generate captured image data, wherein the image sensor provides the preview image data and captured image data to the DSP in parallel, and the DSP merges the preview image data and captured image data to generate the merged image data.

The display may be one of a thin film transistor-liquid crystal display (TFT-LCD), a light emitting diode (LED) display, an organic LED (OLED) display, and an active-matrix OLED (AMOLED) display.

### BRIEF DESCRIPTION OF THE DRAWINGS

The above and other features and advantages of the inventive concept will become more apparent upon consideration of certain exemplary embodiments thereof with reference to the attached drawings in which:

FIG. 1 is a block diagram of an image processing system according to some embodiments of the inventive concept;

FIG. 2 is a block diagram further illustrating in one embodiment (110a) the image sensor 110 of FIG. 1;

FIGS. 3, 4 and 5 are respective block diagrams illustrating operation of an image processing system including an image sensor (110b) according to some embodiments of the inventive concept;

FIG. 6 is a conceptual diagram illustrating exemplary frame rates for a preview image and a captured image output from the image sensor of FIG. 2;

FIG. 7 is a conceptual diagram illustrating a merging operation for a preview image and a captured image according to some embodiments of the inventive concept;

FIG. 8 is a flowchart summarizing operation of an image processing system according to some embodiments of the inventive concept;

FIG. 9 is a flowchart summarizing a method of generating a wide dynamic range (WDR) image using an image processing system according to some embodiments of the inventive concept; and

FIGS. 10 and 11 are block diagrams illustrating respective electronic systems including the image sensor illustrated in FIG. 1 according to some embodiments of the inventive concept.

### DETAILED DESCRIPTION

Certain embodiments of the inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the invention to those skilled in the art. Throughout the written description and drawings, like reference numbers and labels are used to denote like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

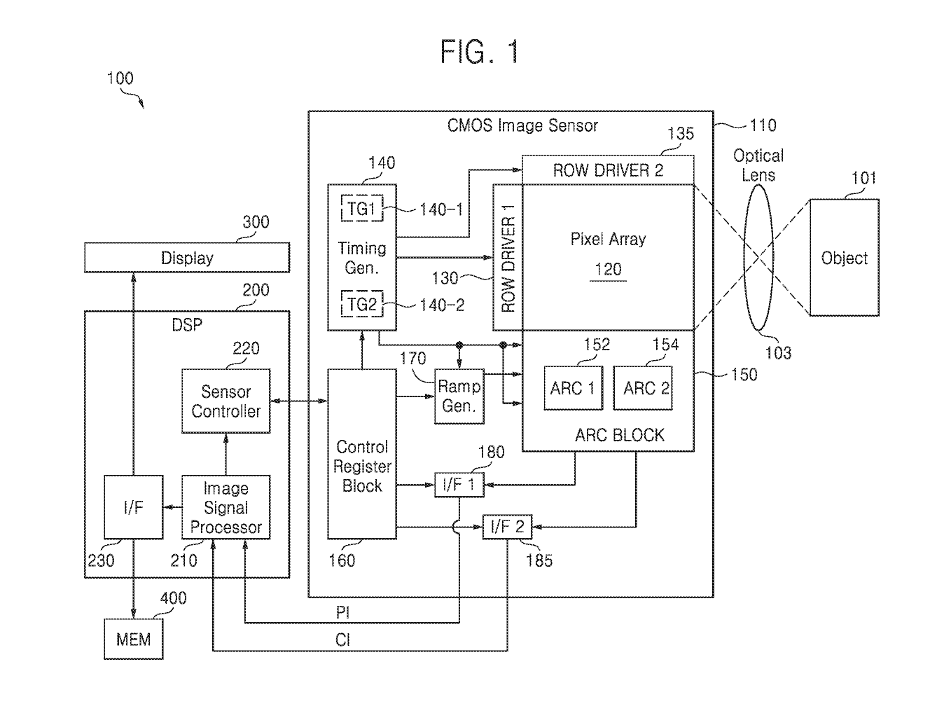

FIG. 1 is a block diagram illustrating an image processing system 100 according to some embodiments of the inventive concept. The image processing system 100 may be implemented as a portable electronic device. The portable electronic device may be a laptop computer, a cellular phone, a smart phone, a tablet personal computer (PC), a personal digital assistant (PDA), an enterprise digital assistant (EDA), a digital still camera, a digital video camera, a portable multimedia player (PMP), a mobile internet device (MID), a wearable computer, an internet of things (IoT) device, an internet of everything (IoE) device, or a drone. The image processing system 100 of FIG. 1 comprises an optical lens 103, a complementary metal-oxide-semiconductor (CMOS) image sensor 110, a digital signal processor (DSP) 200, and a display 300. Here, the CMOS image sensor 110 and DSP 200 may be individually implemented on respective semiconductor chip(s), or collectively implemented on a single semiconductor device such as a semiconductor chip, system-on-chip (SoC), etc.

The CMOS image sensor 110 may be used to generate image data (e.g., “preview image data”, PI and/or “capture image data”, CI described hereafter) corresponding to a visual expression of an “object” that is captured by the optical lens 103. Here, the captured object may be variously expressed in terms of different electromagnetic frequency bands characterizing the so-called “incident light” (e.g., all or part of the visible light spectrum, and/or all or part of infrared spectrum detected by the constituent pixels of the CMOS image sensor 100). Thus, the CMOS image sensor 110 illustrated in FIG. 1 includes a pixel array 120, a first row driver 130, a second row driver 135, a timing generator 140, an analog readout circuit (ARC) block 150, a control register block 160, a ramp generator 170, a first interface (I/F) 180, and a second I/F 185.

The pixel array 120 includes a plurality of pixels, which may be implemented as active pixel sensors arranged in a matrix form. The pixel array 120 includes a plurality of “preview pixels”, each of which may accumulate photo-charge generated in response to incident light and generate a pixel signal corresponding to the accumulated photo-charge. The plurality of preview pixels may be arranged in matrix form. Each preview pixel may include one or more transistors and a photoelectric conversion element, where the photoelectric conversion element may be implemented as a photo diode, a photo transistor, a photogate, or a pinned photo diode.

The pixel array 120 also includes a plurality of “capture pixels” different from the designated preview pixels, where each of the capture pixels may be used to accumulate photo-charge in response to incident light and generate a pixel signal corresponding to the accumulated photo-charge. Here again, the plurality of capture pixels may be arranged in matrix form. And each capture pixel may include one or more transistors and a photoelectric conversion element, where the photoelectric conversion element may be implemented as a photo diode, a photo transistor, a photogate, or a pinned photo diode.

In certain embodiments of the inventive concept, the structure of the capture pixels may be the same as the structure of the preview pixels. For instance, both the preview pixels and capture pixels may have a 4-transistor (4T) structure. In other embodiments of the inventive concept, the structure of the capture pixels may be different from the structure of the preview pixels.

The first row driver 130 may be used to communicate first control signal(s) that control at least the operation of the preview pixels in the pixel array 120 under the control of the timing generator 140. That is, the first row driver 130 may communicate the first control signals associated with the preview pixels in order to control certain operations.

The second row driver 135 may similarly be used to communicate second control signal(s) that control at least the operation of the capture pixels in the pixel array 120 under the control of the timing generator 140. That is, the second row driver 135 may communicate the second control signals associated with the capture pixels in order to control certain operations.

Thus, the timing generator 140 may be used to control the operations of the first row driver 130 and second row driver 135, as well as the ARC block 150 and ramp generator 170 in response to the control of the control register block 160. The timing generator 140 may include a first timing generator 140-1 controlling the first row driver 130 and a second timing generator 140-2 controlling the second row driver 135. The first timing generator 140-1 and the second timing generator 140-2 may operate independently from each other.

The ARC block 150 may be used to read out output signals provided by pixels included in the pixel array 120. In this regard, the ARC block 150 may perform analog-to-digital conversion, and/or correlated double sampling (CDS) in relation to the output signals. For example, the ARC block 150 may perform CDS on “pixel signals” respectively output by one or more column lines of the pixel array 120.

In some additional detail, the ARC block 150 may compare each pixel signal subjected to CDS (e.g., CDS-processed pixel signals may be compared with a ramp signal output from the ramp generator 170) and may generate corresponding comparison signals. The ARC block 150 may then convert each comparison signal into a corresponding digital signal and output a resulting plurality of digital signals to the first I/F 180 and/or the second I/F 185.

As shown in FIG. 1, the ARC block 150 may include a first analog readout circuit 152 and a second analog readout circuit 154. The first analog readout circuit 152 may be used to read out output signals from preview pixels included in the pixel array 120, and the second analog readout circuit 154 may be used to read out output signals from the capture pixels included in the pixel array 120.

The control register block 160 may be used to control the overall operation of the timing generator 140, ramp generator 170, first I/F 180, and/or second I/F 185 under the control of the DSP 200.

In this manner, the first I/F 180 may communicate preview image data PI corresponding to the digital signals output from the ARC block 150 to the DSP 200. Similarly, the second I/F 185 may communicate captured image data CI corresponding to the digital signals output from the ARC block 150 to the DSP 200. In certain embodiments of the inventive concept, the first I/F 180 and second I/F 185 each may be implemented as a buffer or may include a buffer.

The DSP 200 illustrated in FIG. 1 includes an image signal processor 210, a sensor controller 220, and an DSP interface 230. The image signal processor 210 controls the interface 210 and the sensor controller 220 which controls the control register block 160. The image sensor 110 and the DSP 200 may be respectively implemented in separate semiconductor chips or in a single semiconductor package (e.g., a multi-chip package). Alternatively, the image sensor 110 and image signal processor 210 may be respectively implemented in separate semiconductor chips or in a single semiconductor package. As another alternative, the image sensor 110 and image signal processor 210 may be commonly implemented in a single semiconductor chip.

The image signal processor 210 processes the preview image data IP and/or captured image data CI received from the buffer 180 and/or buffer 185, and communicates the resulting “processed image data” to the DSP interface 230. The sensor controller 220 may be used to generate various control signals that control operation of the control register block 160 in response to the image signal processor 210.

The DSP interface 230 may be used to communicate the processed image data from the image signal processor 210 to the display 300. For instance, the DSP interface 230 may communicate the preview image data PI processed by the image signal processor 210 to the display 300. The DSP interface 230 may also communicate the processed image data from the image signal processor 210 to the memory 400. Although only one DSP interface 230 is shown in FIG. 1, the DSP interface 230 may include one interface that communicates some or all of the processed image data to the display 300 and another interface that communicates some or all of the processed image to the memory 400.

The display 300 displays the image data output from the DSP interface 230. The display 300 may be a thin film transistor-liquid crystal display (TFT-LCD), a light emitting diode (LED) display, an organic LED (OLED) display, or an active-matrix OLED (AMOLED) display.

The memory 400 may store the processed image data received from the image signal processor 210 through the DSP interface 230. The memory 400 may be formed of non-volatile memory. The non-volatile memory may be electrically erasable programmable read-only memory (EEPROM), flash memory, magnetic RAM (MRAM), spin-transfer torque MRAM, ferroelectric RAM (FeRAM), phase-change RAM (PRAM), or resistive RAM (RRAM). The non-volatile memory may be implemented as a multimedia card (MMC), an embedded MMC (eMMC), a universal flash storage (UFS), a solid state drive (SSD), a universal serial bus (USB) flash drive, or a hard disk drive (HDD).

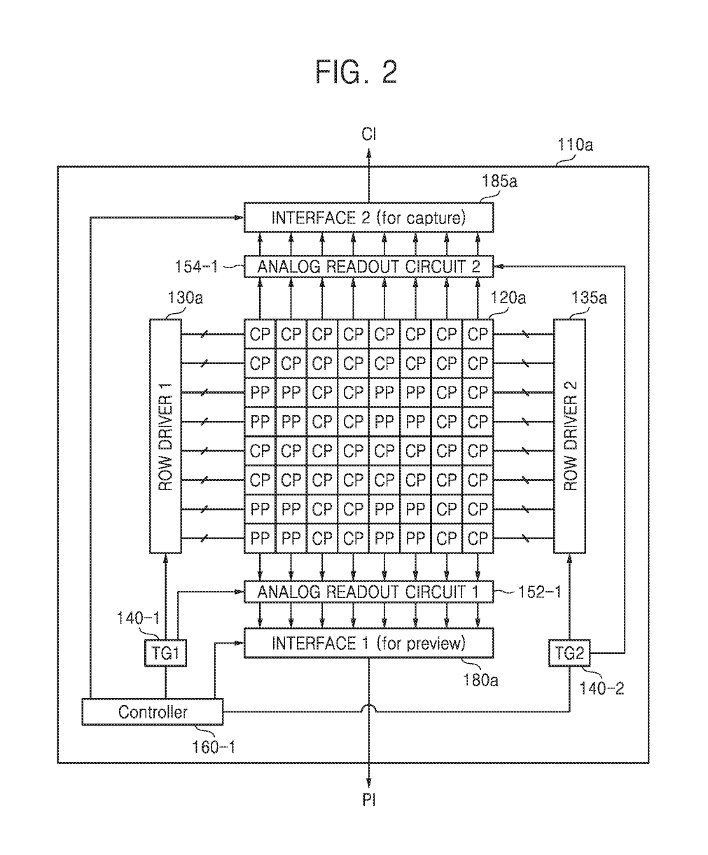

FIG. 2 is a bock diagram further illustrating in one example (a CMOS image sensor 100a) the image sensor 110 of FIG. 1. Referring to FIG. 2, the CMOS image sensor 110a includes a pixel array 120a, a first row driver 130a, a second row driver 135a, a first timing generator 140-1, a second timing generator 140-2, a controller 160-1, a first analog readout circuit 152-1, a second analog readout circuit 154-1, a first I/F 180a, and a second I/F 185a.

In general operation, the CMOS image sensor 110a is a device that converts an optical image (i.e., incident light) into a corresponding electrical signal. It may be implemented in an integrated circuit (IC) and may be used in a digital camera, a camera module, an imaging device, a smart phone, a tablet PC, a camcorder, a PDA, or a MID.

The pixel array 120a of FIG. 2 includes a plurality of pixels, including preview pixels PP and capture pixels CP, where the preview pixels PP are used to generate preview image data PI and the capture pixels CP are used to generate captured image data CI.

As before, some or all of the preview pixels PP may be different, or the same, in structure as some or all of the capture pixels CP. Hence, the preview pixels PP and/or the capture pixels CP may be color pixels (e.g., red pixels, green pixels, blue pixels, and/or white pixels, etc.). The respective positions of individual preview pixels PP and capture pixels within the pixel array 120a may be determined according to a specified user configuration, intended application(s), and/or operating characteristics. Thus, although exemplary positions for preview pixels PP and capture pixels CP are shown in the illustrated embodiments that follow, such positioning is only illustrative.

In FIG. 2, the first row driver 130a is assumed to control the preview pixels PP (e.g., the respective preview pixels PP among the plurality of pixels included in the pixel array 120a). The first row driver 130a receives control signal(s) from the controller 160-1 in order to control the preview pixels PP. In this manner, the first row driver 130a may function as a vertical decoder and a first row driver for preview image data PI.

The second row driver 135a is assumed to control the capture pixels CP (e.g., the capture pixels CP among the plurality of pixels included in the pixel array 120a). The second row driver 135a also receives control signal(s) from the controller 160-1 in order to control the capture pixels CP. In this manner, the second row driver 135a may function as a vertical decoder and a second row driver for the capture pixels CP.

Although in FIG. 2 the first row driver 130a and second row driver 135a are placed at opposite sides of the pixel array 102a, the placement of row drivers 130a and 135a may vary with designs.

The first timing generator 140-1 may be used to control the operation of the first row driver 130a in response to the controller 160-1. Hence, the first timing generator 140-1 may communicate a first timing signal to the first row driver 130a, and the first row driver 130a may output the preview image data PI of the preview pixels PP according to the first timing signal.

The second timing generator 140-2 may control the operation of the second row driver 135a according to the control of the controller 160-1. In detail, the second timing generator 140-2 may communicate a second timing signal to the second row driver 135a and the second row driver 135a may output the captured image data CI of the capture pixels CP according to the second timing signal.

The first analog readout circuit 152-1 may read out output signals of the preview pixels PP included in the pixel array 120a and may output the readout signals to the first I/F 180a. The second analog readout circuit 154-1 may read out output signals of the capture pixels CP included in the pixel array 120a and may output the readout signals to the second I/F 185a.

The controller 160-1 may control the first row driver 130a and the second row driver 135a to output the preview image data PI and captured image data CI in parallel. The controller 160-1 may perform the same function or a different function than the control register block 160 illustrated in FIG. 1.

Referring to FIGS. 1 and 2, the controller 160-1 may communicate a timing control signal to the first timing generator 140-1 and the second timing generator 140-2 so that the first timing generator 140-1 controls output of the preview image data PI via the first row driver 130a and the second timing generator 140-2 controls output of the captured image data CI via the second row driver 135a. In addition, the controller 160-1 may communicate a timing control signal to the first timing generator 140-1, such that the first timing generator 140-1 controls the first analog readout circuit 152-1 to allow the preview image data PI to be output to the first I/F 180a. Similarly, the controller 160-1 may communicate a timing control signal to the second timing generator 140-2, such that the second timing generator 140-2 may control the second analog readout circuit 154-1 to allow the captured image data CI to be output to the second I/F 185a. In this manner, the controller 160-1 may control the first analog readout circuit 152-1 and the second analog readout circuit 154-1 so that the preview image data PI and the captured image data CI are output in parallel.

The controller 160-1 may control the output of the captured image data CI via the second analog readout circuit 154-1 while the preview image data PI is being output via the first analog readout circuit 152-1. When the captured image data CI is output via the second analog readout circuit 154-1, the controller 160-1 may also maintain the first analog readout circuit 152-1 active so that the preview image data PI is output via the first analog readout circuit 152-1.

The output frame rate for the preview image data PI provided by the preview pixels PP may be higher than the output frame rate for the captured image data CI provided by the capture pixels CP. In other words, the controller 160-1 may set one frame rate for the preview image data PI and another frame rate for the captured image data CI.

The controller 160-1 also controls the first I/F 180a and the second I/F 185a to output the preview image data PI and the captured image data CI in parallel. That is, the controller 160-1 may control the captured image data CI output via the second I/F 185a while the preview image data PI is being output via the first I/F 180a. When the captured image data CI is output via the second I/F 185a, the controller 160-1 may also maintain the first I/F 180a active so that the preview image data PI is output via the first I/F 180a.

Additionally or alternatively, the controller 160-1 may control a first exposure time for the preview pixels PP and a second exposure time for the capture pixels CP. These two exposure times (or first and second durations) may be the same or different. Thus, the controller 160-1 may control the preview pixels PP to be exposed for a first duration, while independently controlling the capture pixels CP to be exposed for a second duration. In other words, the controller 160-1 may control an exposure time of each of the pixels included in the pixel array 120a according to defined type. The first duration may be longer or shorter than the second duration. The first duration and the second duration may be determined according to a user's configuration or application.

In the illustrated example of FIG. 2, the first I/F 180a receives the preview image data PI generated in response to the preview pixels PP and outputs corresponding preview image data PI. The second I/F 185a receives the captured image data CI generated by the capture pixels CP and outputs corresponding captured image data CI. As a result, the first I/F 180a and second I/F 185a may respectively output the preview image data PI and captured image data CI in parallel. In other words, the first I/F 180a and second I/F 185a may respectively output the preview image data PI and the captured image data CI via separate data communication paths.

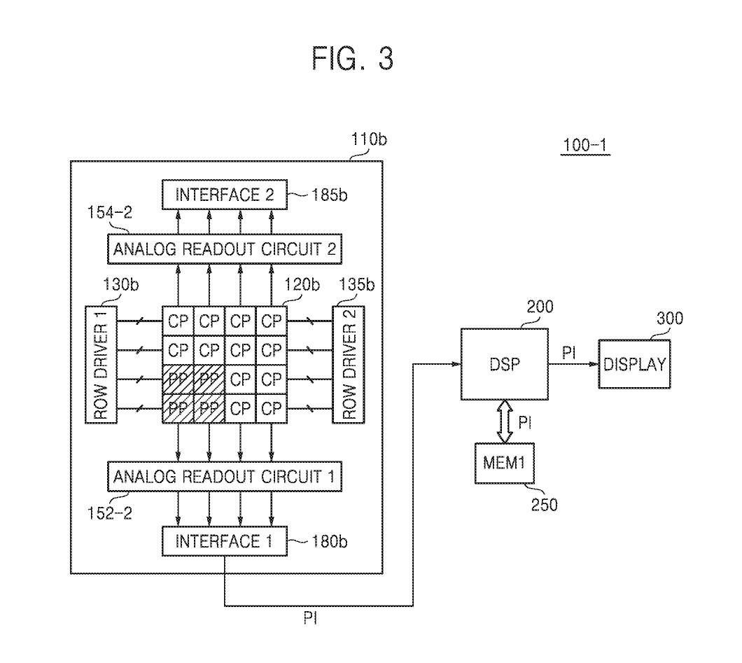

Although the pixel array 120a shown in FIG. 2 is a simple 8-by-8 pixel array, those skilled in the art will recognize that scope the inventive concept extends to any reasonably sized pixel array and number of constituent pixels. This being the case, the various pixel array embodiments (120b) illustrated in FIGS. 3, 4, 5, 6 and 7 are merely exemplary in nature.

FIG. 3 is a block diagram illustrating operation of an image processing system 100-1 providing preview image data PI according to some embodiments of the inventive concept. Referring to FIG. 3, the image processing system 100-1 includes an image sensor 100b, the DSP 200, a first memory 250, and display 300. The image processing system 100-1 may be substantially the same as the image processing system 100 of FIG. 1. The DSP 200 and the display 300 may also be substantially the same as or similar to those illustrated in FIG. 1.

The image sensor 100b may be substantially the same as the image sensor 100a of FIG. 2. Hence, the image sensor 100b may include a pixel array 120b, a first row driver 130b, a second row driver 135b, a first analog readout circuit 152-2, a second analog readout circuit 154-2, a first I/F 180b, and a second I/F 185b. The pixel array 120b, the first row driver 130b, the second row driver 135b, the first analog readout circuit 152-2, the second analog readout circuit 154-2, the first I/F 180b, and the second I/F 185b illustrated in FIG. 3 may substantially be the same as the corresponding elements 120a, 130a, 135b, 152-1, 154-1, 180a, and 185a of FIG. 2.

The image sensor 100b may be used to communicate preview image data PI generated by the preview pixels PP to the DSP 200 via the first I/F 180b. The DSP 200 may receive and process the preview image data PI and communicate the processed preview image data PI to the display 300. That is, the DSP 200 may perform image signal processing on the preview image data PI.

With respect to FIGS. 3, 4, 5 and 6, both a preview image before being processed and a preview image after being processed are referred to as the preview image data PI, and both a captured image before being processed and a captured image after being processed are referred to as the captured image data CI.

The DSP 200 may be used to communicate the processed preview image data PI to the first memory 250. According to certain embodiments of the inventive concept, the DSP 200 may receive the preview image data PI and communicate it ‘on-the-fly’ to the display 300 via the first memory 250.

The first memory 250 may receive the preview image data PI and communicate it to the DSP 200. The first memory 250 may function to realize an on-the-fly mode between the DSP 200 and the display 300. The first memory 250 may be formed of volatile memory. The volatile memory may be random access memory (RAM), static RAM (SRAM), dynamic RAM (DRAM), synchronous DRAM (SDRAM), thyristor RAM (T-RAM), zero capacitor RAM (Z-RAM), or twin transistor RAM (TTRAM).

The display 300 may receive the preview image data PI from the DSP 200 and display the preview image data PI. The display 300 may display the preview image data PI using the preview pixels PP corresponding to a part of the pixel array 120b. Accordingly, power consumption by the display 300 may be reduced, as compared with conventional image processing systems wherein the display 300 always displays image data using all pixels included in the pixel array 120b.

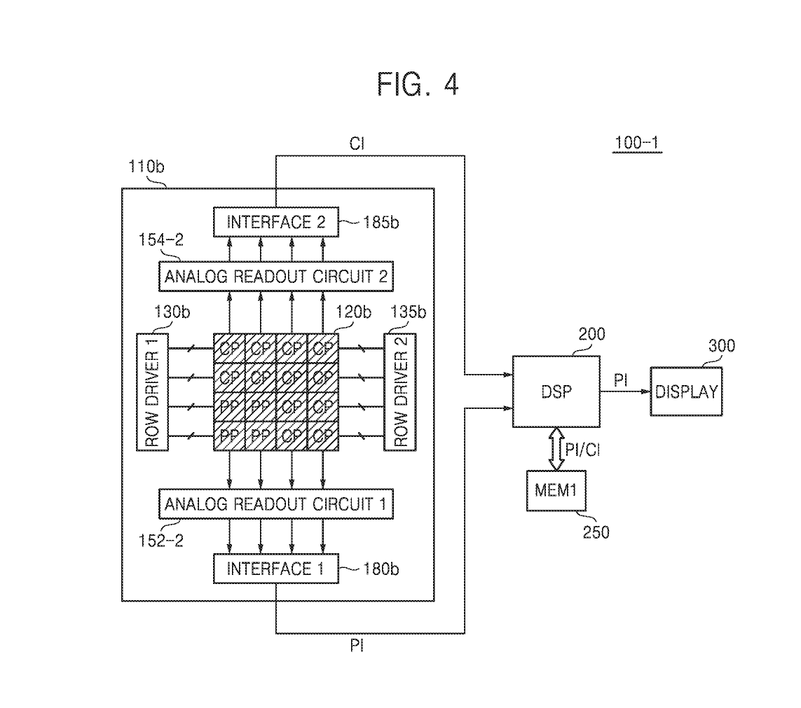

FIG. 4 is a block diagram illustrating operation of the image processing system 100-1 wherein preview image data PI and captured image data CI are provided in parallel according to some embodiments of the inventive concept. Referring to FIGS. 3 and 4, the image processing system 100-1 may include the image sensor 100b, DSP 200, first memory 250, and display 300. The image processing system 100-1 may be substantially the same as the image processing system 100-1 illustrated in FIG. 3.

The image sensor 100b may simultaneously communicate to the DSP 200 both the preview image data PI generated by the preview pixels PP and output by the first analog readout circuit 152-2 via the first I/F 180b, as well as the captured image data CI generated by the capture pixels CP and communicated via the second I/F 185a. The first analog readout circuit 152-2 may communicate the preview image data PI to the DSP 200 via the first I/F 180b and the second analog readout circuit 154-2 may communicate the captured image data CI to the DSP 200 via the second I/F 185b, where the first I/F 180b and second I/F 185b may be separately implemented.

Hence, the image sensor 100b communicates the preview image data PI and captured image data CI to the DSP 200 in parallel, at least in part, via the first I/F 180b and second I/F 185b, respectively. The image sensor 100b may set a frame rate for the preview image data PI that is higher than that for the captured image data CI, and may communicate the preview image data PI and the captured image data CI in parallel to the DSP 200 according to such frame rates.

When the image sensor 100b receives a capture command instructing it to “capture” a still image while preview image data PI is being communicated, the image sensor 100b may then communicate corresponding capture image data CI to the DSP 200 via the second analog readout circuit 154-2 and second I/F 185b. In other words, when receiving the capture command during the communication of preview image data PI to the DSP 200, the image sensor 100b may also—upon user activated command—communicate captured image data CI to the DSP 200.

The DSP 200 may receive the preview image data PI and captured image data CI in parallel, and simultaneously process both preview image data PI and captured image data CI. The DSP 200 may then communicate the resulting processed preview image data PI and processed captured image data CI to the first memory 250. In other words, the DSP 200 may receive and process the preview image data PI and captured image data CI and communicate the processed preview image data PI and processed captured image data CI to the first memory 250.

Hence, the DSP 200 may receive the preview image data PI and captured image data CI, and communicate the preview image data PI to the display 300 on the fly through the first memory 250. In this manner, the DSP 200 may communicate only the preview image data PI to the display 300.

The first memory 250 receives the preview image data PI and captured image data CI from the DSP 200, where the first memory 250 may perform a function substantially the same as the function performed by the first memory 250 illustrated in FIG. 3.

The display 300 may receive the preview image data PI from the DSP 200 and display the preview image data PI. In other words, the display 300 need not always receive captured image data CI, but instead may receive and display only the preview image data PI.

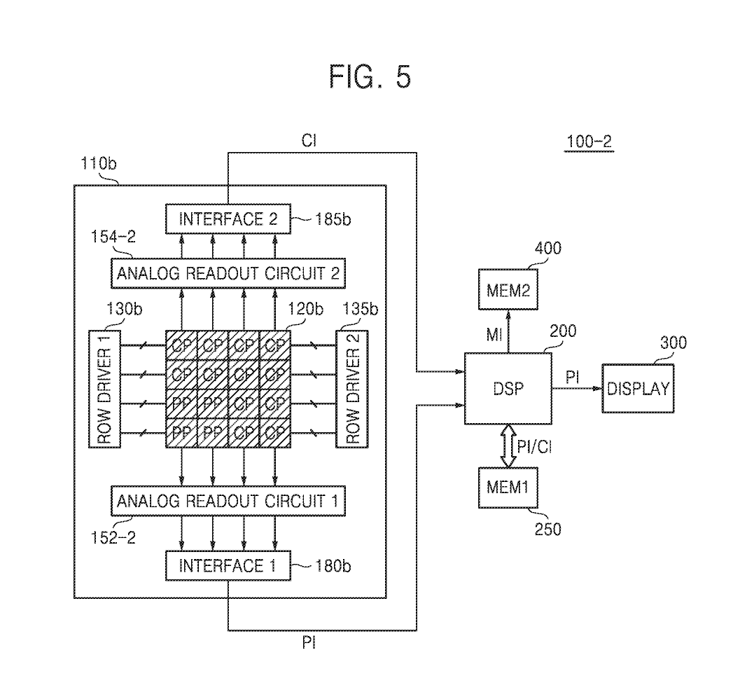

FIG. 5 is another block diagram illustrating operation of an image processing system 100-2 that merges preview image data PI with captured image data CI according to some embodiments of the inventive concept. Referring to FIG. 5, the image processing system 100-2 may include the image sensor 100b, the DSP 200, the first memory 250, the display 300, and the second memory 400. The image processing system 100-2 may substantially be the same as or similar to the image processing system 100-1 illustrated in FIG. 4 excepting for the second memory 400. The image sensor 100b may be substantially the same as the image sensor 100b illustrated in FIG. 4. The DSP 200 may be substantially the same as the DSP 200 illustrated in FIG. 4.

The DSP 200 may receive the preview image data PI and captured image data CI in parallel, and merge the preview image data PI with the captured image data CI. The DSP 200 may alternately communicate only the preview image data PI to the display 300 while the preview image data PI is being merged with the captured image data CI. The DSP 200 may communicate the resulting merged image data MI to the second memory 400. The DSP 200 may merge the preview image data PI and captured image data CI when receiving a shooting command instructing it to capture a still image, and may thereafter communicate the merged image data MI to the second memory 400. Alternately or additionally, the display 300 may display the preview image data PI. The display 300 may be substantially the same as the display 300 illustrated in FIGS. 3 and 4.

The second memory 400 may receive and store the merged image MI, where the second memory 400 may be substantially the same as the memory 400 illustrated in FIG. 1.

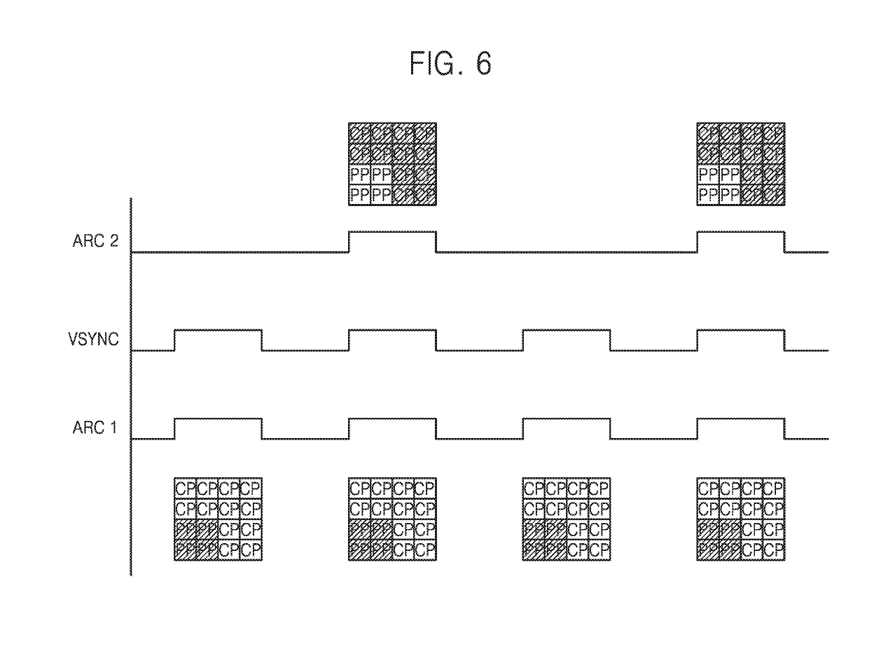

FIG. 6 is a conceptual diagram illustrating one frame rate for the preview image data PI and another frame rate for the captured image data CI, as respectively provided by the image sensor 110a of FIG. 2. Referring collectively to the foregoing embodiments, the signal ARC1 indicates a first frame rate for the preview image data PI provided by the first analog readout circuit 152, 152-1, or 152-2 and communicated via the first I/F 180, 180a, or 180b. Similarly, the signal ARC2 indicates a second frame rate for the captured image data CI provided by the second analog readout circuit 154, 154-1, or 154-2, and communicated via the second I/F 185, 185a, or 185b. For further reference, a vertical sync signal VSYNC is also shown in FIG. 6.

The first analog readout circuit 152, 152-1, or 152-2 provides the preview image data PI synchronously with the vertical sync signal VSYNC, and the second analog readout circuit 154, 154-1, or 154-2 provides the captured image data CI at a frame rate equal to one-half the frame rate for the preview image data PI. Although the frame rate for the captured image data CI is half of that for the preview image data PI in the embodiments illustrated in FIG. 6, the inventive concept is not limited to only the specific frame rates described in the illustrated embodiments.

Upon receiving a capture command during generation of preview image data PI via the first analog readout circuit 152, 152-1, or 152-2, the image sensor 110, 110a, or 110b may provide corresponding captured image data CI via the second analog readout circuit 154, 154-1, or 154-2. In other words, the image sensor 110, 110a, or 110b may either output captured image data CI at a second frame rate that is lower than a first frame rate for the preview image data PI, or output captured image data CI in response to an incoming capture command. Additionally, the image sensor 110, 110a, or 110b may provide preview image data PI using only certain designated pixels included in the pixel array 120, thereby reducing overall power consumption.

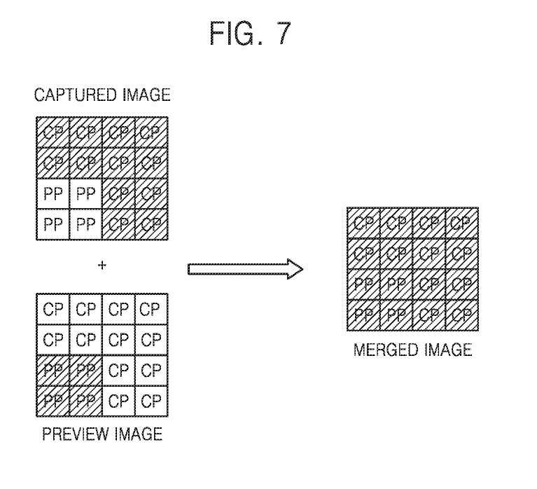

FIG. 7 is a conceptual diagram illustrating an operation of merging preview image data PI with captured image data CI according to certain embodiments of the inventive concept. Referring to the foregoing embodiments, the image sensor 110, 110a, or 110b may be used to communicate preview image data PI and captured image data CI to the DSP 200 in parallel.

The DSP 200 receives the preview image data PI and captured image data CI, being communicated in parallel, and merges the preview image data PI and captured image data CI. Here, as before, the preview image data PI may be generated by the preview pixels PP in the pixel array 120 and the captured image data CI may be generated by the capture pixels CP in the pixel array 120. Under these conditions, a high resolution image may be required, for example, during the acquisition of a still shot, and therefore, a lot of pixels are necessary to capture the required image. Accordingly, the DSP 200 may output an image using all pixels included in the pixel array 120 in order to provide a high resolution still shot, for example.

Accordingly, the DSP 200 may merge preview image data PI generated by the preview pixels PP with captured image data CI generated by the capture pixels CP in order to generate merged image data MI, such as the type used to generate a still shot image of relatively higher resolution. In certain embodiments of the inventive concept, the DSP 200 may merge the preview image data PI generated by exposing the preview pixels PP for a first duration with the captured image data CI generated by exposing the capture pixels CP for a second duration different from, or the same as, the first duration. In this manner, for example, the DSP 200 may generate merged image data MI having a relatively wide dynamic range (WDR) using preview image data PI generated with a first exposure duration and captured image data CI generated with a second exposure.

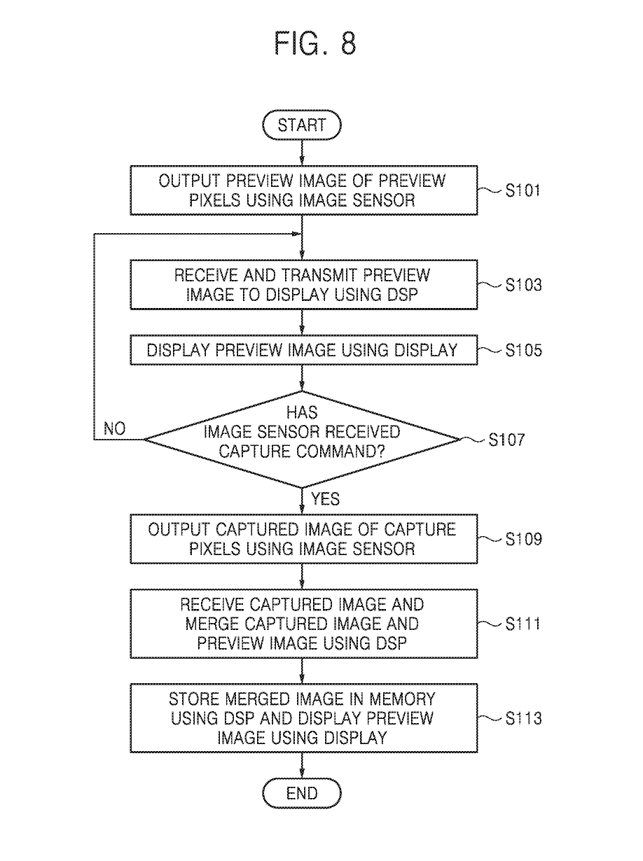

FIG. 8 is a flowchart summarizing operation of an image processing system according to some embodiments of the inventive concept. Referring to the foregoing embodiments, the image sensor 110, 110a, or 110b may be used to output preview image data PI generated by the preview pixels PP via the first analog readout circuit 152 and first I/F 180 in operation S101.

The DSP 200 receives and communicates the preview image data PI to the display 300 in operation S103. The DSP 200 may communicate the preview image data PI to the display 300 on the fly. The display 300 may display the preview image data PI in operation S105.

When the image sensor 110, 110a, or 110b receives a capture command instructing the capture of a particular image in operation S107, the image sensor 110, 110a, or 110b may output corresponding captured image data CI using the capture pixels CP in operation S109. So long as the image sensor 110, 110a, or 110b does not receive a capture command, the image sensor 110, 110a, or 110b will not output the captured image data CI. Alternatively, even when the image sensor 110, 110a, or 110b does not receive a capture command, the image sensor 110, 110a, or 110b may output the captured image data CI at a second frame rate different from a first frame rate associated with the preview image data PI. For example, the second frame rate for the captured image data CI may be lower than that for the first frame rate for the preview image data PI.

The DSP 200 may receive the captured image data CI and may merge the captured image data CI and the preview image data PI in operation S111. Upon receiving a command instructing the acquisition of a still shot, the DSP 200 may also merge the captured image data CI and the preview image data PI. The DSP 200 may then communicate the preview image data PI and merging of the captured image data CI and the preview image data PI at the same time.

The DSP 200 may store the merged image MI in the memory 400 and the display 300 may display the preview image data PI in operation S113. While the DSP 200 is storing the merged image MI in the memory 400, the display 300 may display the preview image data PI in operation S113.

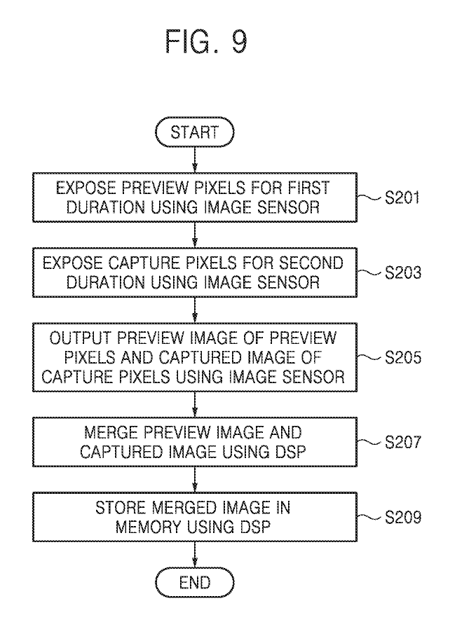

FIG. 9 is another flowchart summarizing a method of generating a WDR image using an image processing system according to some embodiments of the inventive concept. Referring to that foregoing embodiments, the image sensor 110, 110a, or 110b may output preview image data PI generated by the preview pixels PP via the first analog readout circuit 152 and first I/F 180.

The image sensor 110, 110a, or 110b may expose the preview pixels PP for a first duration in operation S201 and may expose the capture pixels CP for a second duration in operation S203. The first duration and the second duration may be set by the controller 160. Setting conditions may be determined by a user or a program. In this context, the term “expose” means to establish a time duration during which the respective pixels are subjected in incident light. The first duration may be different from the second duration, wherein the first duration may be longer or shorter than the second duration.

The image sensor 110, 110a, or 110b may output the preview image data PI of the preview pixels PP and the captured image data CI of the capture pixels CP in operation S205. For instance, the image sensor 110, 110a, or 110b may output the preview image data PI generated with an exposure for the first duration and the captured image data CI generated with an exposure for the second duration.

The DSP 200 may merge the preview image data PI with the captured image data CI in operation S207. In other words, the DSP may merge image data generated from pixels having different exposure times. The DSP 200 may generate the merged image MI using the preview image data PI and captured image data CI, and may thereafter generate a WDR image using the merged image MI. The DSP 200 may store the merged image MI in the memory 400 in operation S209.

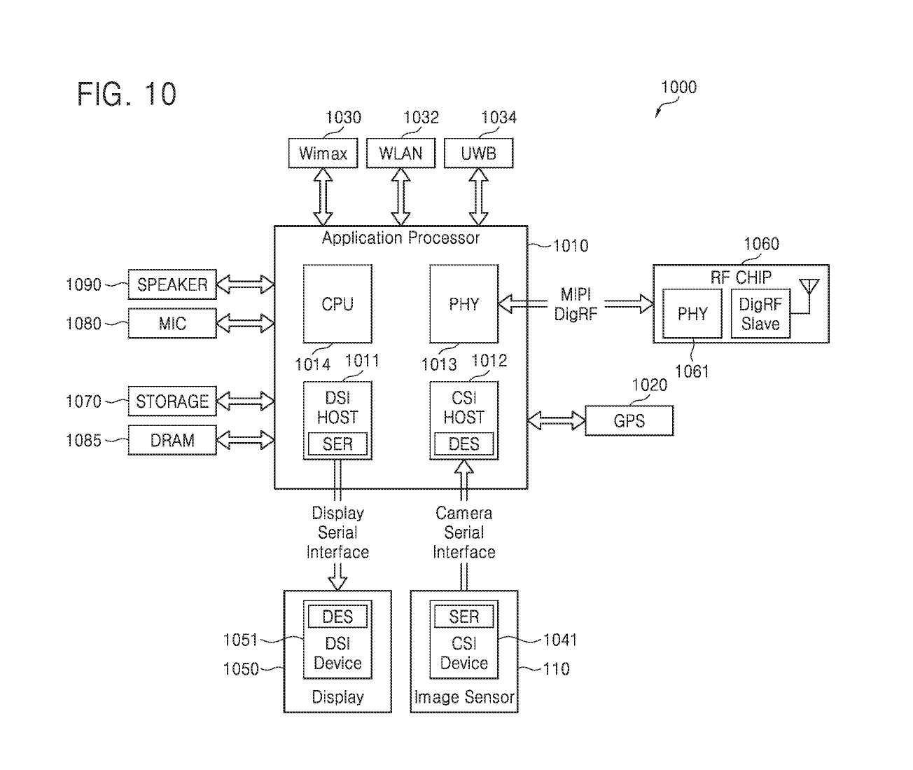

FIG. 10 is a block diagram illustrating an electronic system including, an image sensor like the image sensor shown in FIG. 1 according to some embodiments of the inventive concept. Referring collectively to the foregoing embodiments, the electronic system may be implemented as an image processing system 1000 capable of using or supporting the mobile industry processor interface (MIPI). The image processing system 1000 may be a laptop computer, a cellular phone, a smart phone, a tablet PC, a PDA, an EDA, a digital still camera, a digital video camera, a PMP, a MID, a wearable computer, an IoT device, or an IoE device.

The image processing system 1000 includes an application processor 1010, the image sensor 110, and the display 1050. A camera serial interface (CSI) host 1012 in the application processor 1010 may perform serial communication with a CSI device 1041 in the image sensor 110 through CSI. A de-serializer DES and a serializer SER may be included in the CSI host 1012 and the CSI device 1041, respectively.

As described above with reference to the embodiments, such as those shown in FIGS. 1 through 10, the image sensor 110 includes preview pixels PP and capture pixels CP 20. A display serial interface (DSI) host 1011 in the application processor 1010 may perform serial communication with a DSI device 1051 in the display 1050 through DSI. A serializer SER and a de-serializer DES may be included in the DSI host 1011 and the DSI device 1051, respectively. The preview image data PI and/or captured image data CI generated by the image sensor 110 may be further communicated to the application processor 1010 via a CSI. The application processor 1010 may process the preview image data PI and/or captured image CI and may communicate the variously processed image data to the display 1050 using a DSI.

The image processing system 1000 may also include a radio frequency (RF) chip 1060 communicating with the application processor 1010. A physical layer (PHY) 1013 in the application processor 1010 and a PHY 1061 in the RF chip 1060 may communicate data with each other according to MIPI DigRF.

A central processing unit (CPU) 1014 may control the operations of the DSI host 1011, the CSI host 1012, and the PHY 1013. The CPU 1014 may include at least one core. The application processor 1010 may be implemented in an IC or a system on chip (SoC). The application processor 1010 may be a processor or a host that can control the operations of the image sensor 110.

The image processing system 1000 may further include a global positioning system (GPS) receiver 1020, a volatile memory 1085 such as DRAM, a data storage 1070 formed using non-volatile memory such as flash-based memory, a microphone (MIC) 1080, and/or a speaker 1090. The data storage 1070 may be implemented as an external memory detachable from the application processor 1010. The data storage 1070 may also be implemented as a UFS, an MMC, an eMMC, or a memory card. The image processing system 1000 may communicate with external devices using at least one communication protocol or standard, e.g., ultra-wideband (UWB) 1034, wireless local area network (WLAN) 1132, worldwide interoperability for microwave access (Wimax) 1030, or long term evolution (LTETM) (not shown). In other embodiments, the image processing system 1000 may also include a near field communication (NFC) module, a WiFi module, or a Bluetooth module.

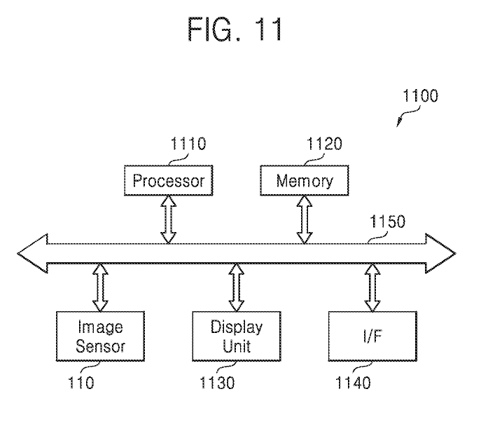

FIG. 11 is a block diagram illustrating an electronic system 1100 including the image sensor 110 illustrated in FIG. 1 according to other embodiments of the inventive concept. Referring to the foregoing embodiments, the electronic system 1100 may include the image sensor 100, a processor 1110, a memory 1120, a display unit 1130, and an I/F 1140. The image sensor 110, the processor 1110, the memory 1120, the display unit 1130, and the I/F 1140 may communicate data with one another through a channel 1150.

The processor 1110 may control the operation of the image sensor 110. For instance, the processor 1110 may process pixel signals output from the image sensor 110 to generate image data. The memory 1120 may store a program for controlling the operation of the image sensor 110 and the image data generated by the processor 1110. The processor 1110 may execute the program stored in the memory 1120. The memory 1120 may be implemented as a volatile or non-volatile memory.

The display unit 1130 may display the image data output from the processor 1110 or the memory 1120. The I/F 1140 may be implemented to input and output image data. The I/F 1140 may be implemented as a wireless interface.

As described above, according to embodiments of the inventive concept, an image sensor providing a live view (e.g., a preview image) and also providing in parallel a still-shot image in response to a user action, need not undergo a display (e.g., an LCD) blackout. In addition, the image sensor may provide the preview image instead of a still-shot image (or a full-size image) to remove LCD blackout, thereby reducing power consumption.

While the inventive concept has been particularly shown and described with reference to exemplary embodiments thereof, it will be understood by those of ordinary skill in the art that various changes in forms and details may be made therein without departing from the scope of the inventive concept as defined by the following claims.

What is claimed is:

1. An image sensor comprising:
a pixel array including preview pixels and capture pixels;
a first readout circuit that communicates preview image data generated by the preview pixels to a Digital Signal Processor (DSP) via a first interface;
a second readout circuit that communicates captured image data generated by the capture pixels to the DSP via a second interface different from the first interface; and
a controller that controls operation of the first readout circuit and second readout circuit, such that the preview image data and captured image data are provided to the DSP in parallel.

2. The image sensor of claim 1, wherein the preview image data is provided at a first frame rate and the captured image data is provided at a second frame rate different from the first frame rate.

3. The image sensor of claim 1, wherein the preview image data is provided at a first frame rate and the captured image data is provided at a second frame rate lower than the first frame rate.

4. The image sensor of claim 1, wherein the controller controls the second readout circuit to communicate the captured image data to the DSP via the second readout circuit in response to a capture command received while the preview image data is being communicated to the DSP via the first readout circuit.

5. The image sensor of claim 4, wherein the image sensor maintains the first readout circuit active so that the preview image data is communicated to the DSP via the first readout circuit while the captured image data is communicated to the DSP via the second readout circuit.

6. The image sensor of claim 1, wherein the controller exposes the preview pixels during a first exposure time and exposes the capture pixels for a second exposure time different from the first exposure time.

7. An image processing system comprising:
an image sensor that provides in parallel preview image data and captured image data; and
a Digital Signal Processor (DSP) that receives in parallel the preview image data and captured image data and merges the preview image data and captured image data to generate merged image data.

8. The image processing system of claim 7, wherein the image sensor comprises:
a pixel array including preview pixels and capture pixels;
a first readout circuit that communicates the preview image data generated by the preview pixels to the DSP via a first interface;
a second readout circuit that communicates the captured image data generated by the capture pixels to the DSP via a second interface different from the first interface; and
a controller that controls operation of the first readout circuit and second readout circuit, such that the preview image data and captured image data are provided to the DSP in parallel.

9. The image processing system of claim 8, wherein the preview image data is provided at a first frame rate and the captured image data is provided at a second frame rate different from the first frame rate.

10. The image processing system of clam 8, wherein the preview image data is provided at a first frame rate and the captured image data is provided at a second frame rate lower than the first frame rate.

11. The image processing system of claim 8, wherein the controller controls the second readout circuit to communicate the captured image data to the DSP in response to a capture command received while the preview image data is being communicated to the DSP via the first readout circuit.

12. The image processing system of claim 11, wherein the image sensor maintains the first readout circuit active so that the preview image data is communicated to the DSP via the first readout circuit when the captured image is communicated to the DSP via the second readout circuit.

13. The image processing system of claim 8, wherein the controller exposes the preview pixels during a first exposure time and exposes the capture pixels for a second exposure time different from the first exposure time.

14. An electronic device, comprising:
a Digital Signal Processor (DSP) that generates merged image data;
a display that displays an image in response to the merged image data received from the DSP; and
an image sensor including a pixel array comprising preview pixels that generate preview image data and capture pixels that generate captured image data,
wherein the image sensor provides the preview image data and captured image data to the DSP in parallel, and
the DSP merges the preview image data and captured image data to generate the merged image data.

15. The electronic device of claim 14, wherein the display is one of a thin film transistor-liquid crystal display (TFT-LCD), a light emitting diode (LED) display, an organic LED (OLED) display, and an active-matrix OLED (AMOLED) display.

16. The electronic device of claim 15, wherein the image sensor comprises:
a first readout circuit that communicates the preview image data to the DSP via a first interface;
a second readout circuit that communicates the captured image data to the DSP via a second interface different from the first interface; and
a controller that controls operation of the first readout circuit and second readout circuit, such that the preview image data and captured image data are provided to the DSP in parallel.

17. The electronic device of claim 16, wherein the preview image data is provided at a first frame rate and the captured image data is provided at a second frame rate different from the first frame rate.

18. The electronic device of claim 16, wherein the controller controls the second readout circuit to communicate the captured image data to the DSP in response to a capture command received in response to a user input while the preview image data is being communicated to the DSP via the first readout circuit.

19. The electronic device of claim 18, wherein the image sensor maintains the first readout circuit active so that the preview image data is communicated to the DSP via the first readout circuit when the captured image is communicated to the DSP via the second readout circuit.

20. The electronic device of claim 19, wherein the display does not undergo a blackout in response to the user input.
